(19) United States
(12) Patent Application Publication
(10) Pub. No.: US 2002/0107911 A1
(43) Pub. Date: Aug. 8, 2002

(54) Method for enhancing client side delivery of information from a trusted server

(75) Inventors: Steven Jay Lipton, Flower Mound, TX (US); Rick Allen Hamilton II, Charlottesville, VA (US)

Correspondence Address: Cynthia S. Byrd, IBM Corporation, 11400 Burnet Rd., Austin, TX, 78758, US

(73) Assignee: INTERNATIONAL BUSINESS MACHINES CORPORATION, ARMONK, NY (US)

(21) Appl. No.: 09/779,360

(22) Filed: Feb. 8, 2001

(51) Int. Cl. G06F 15/16; G09G 5/00

(52) U.S. Cl. 709/203; 345/738

(57) ABSTRACT

A system for and a method of enhancing information delivery to a client is disclosed. A operator at a server accesses at least one configuration file comprising instructions for displaying a URL at a given time and date. The server system time and date are verified and a configuration file is transmitted to the client, when the time and date function of the configuration file corresponds to the server system time and date. A document is displayed at the client based on a given system time and date.

### TECHNICAL FIELD

The present invention relates to a method for and a system of enhancing client side delivery of information from a trusted server. More particularly, the invention relates to a method of and system for delivering web content to a client machine based on server defined preferences.

### BACKGROUND OF THE INVENTION

The Internet is a world wide communication network, enabling computer users to connect to other computer users. Users on local area computer networks are also interconnected via the Internet to send and receive information to other users on other local area computer networks. The world wide web is the multimedia portion of the Internet which provides full color graphics and sound.

Using the Internet and accessing the world wide web, has been made easier by the proliferation of web browser programs. A web browser is a software utility device which provides the user with a simple graphical user interface to navigate the Internet. With a web browser, the user can navigate through the Internet by selecting options from icons and menus with a point and click mouse. Typically, a web browser, upon initially connecting to the Internet, accesses and displays a specified document, often referred to as a “home page”.

The typical web browser includes a function that allows the user to specify a particular URL for the home page. When the web browser initially connects to the Internet, the web site associated with the selected URL is displayed. Likewise when the user selects the “home” button, the browser displays the default home page. Most users typically do not change the default home page setting.

When a user wants to mark or remember a particular URL for future reference, they typically copy the URL to their “bookmark” file or “favorites” file, depending upon the browser. In order to retrieve a desired web page, network users and in particular web browser users manually direct their web browsers to specific network sites either by selecting the corresponding bookmark or by entering the URL. This effort is time consuming and requires the user to remember which sites to display and when to display them. There currently is no way to automatically display information at times that are tailored by an individual user. A method and system that enables users to enter web sites to be displayed at given times would be very useful.

### SUMMARY OF THE INVENTION

The present invention provides a method of enhancing information delivery to a client system. A trusted server is used to transfer configuration files to various clients at given times. At least one configuration file comprising instructions for displaying a URL at a given time and date is accessed at the server. Upon verification of the server system time and date, a configuration file is transmitted from the server to the client. The time and date function of the configuration file corresponds to the server system time and date. The configuration file causes a first document to be displayed at the client based on a first system time and date. Preferably, a second document is displayed at the client based on a second system time and date.

### BRIEF DESCRIPTION OF THE DRAWINGS

The foregoing and other features and advantages of the present invention will become more apparent from the detailed description of the best mode for carrying out the invention as rendered below. In the description to follow reference will be made to the accompanying drawings, where like reference numerals are used to identify like parts in the various views in which:

FIG. 1 is an example of a client-server data processing system suitable for use in the present invention;

FIG. 2 is a block diagram of components found on an exemplary server in accordance with the present invention;

FIG. 2A is a block diagram of components found on an exemplary client in accordance with the present invention;

FIG. 3 is a schematic diagram of a client computer system suitable for use in the present invention;

FIG. 4 is flow diagram of a process for creating a master input file in accordance with the present invention;

FIG. 5 is a flow diagram of a process for creating custom preferences files on a client in accordance with a preferred embodiment of the present invention;

FIG. 6 is a flow diagram of a process for creating schedule script files in accordance with the present invention; and

FIG. 7 is a flow diagram of a process for running a schedule script on a server in accordance with a preferred embodiment of the present invention.

### DETAILED DESCRIPTION OF THE PREFERRED EMBODIMENT

The present invention is directed to a method for providing customized home pages to a client at predetermined times. The method includes pushing a configuration file to the client from a trusted server. In a typical browser such as Netscape Navigator, for example, the preferences or configuration file that determines which home page is displayed is a javascript-generated file called “prefs.js.” In the prefs.js file, specifications are given for startup “home” such as:

user_pref(”browser.startup.homepage”, “http://www.ibm.com”)

Microsoft's Internet Explorer uses similar configuration files to specify the home page. The present invention is implemented by modifying these configuration files as needed throughout the day or any other defined time frame.

The configuration files on the client are modified by pushing the updated files out to the client through a trusted server. A “trusted server” is a server that has the appropriate authority to access clients and transfer information to the client under acceptable security standards. Acceptable security standards are well known in the art and act to assure a secure connection between the server issuing the new configuration file and the receiving client. The security mechanism used will vary depending upon the operating system and the server administrator's preference. A secure server using a UNIX operating system would use the Berkeley commands (e.g., “rcp”) to place the new configuration files on the client machines. Other security mechanisms, such as a trusted Kerberos protocol, could be used.

The present invention utilizes server pushes to client browser configuration files; by doing so, a trusted server can help control the flow of information to the end user, with no change to existing browser architecture. Pushing browser configuration files to clients via sophisticated time-aware programs on a centralized server will help deliver relevant information content customized to each user's needs.

An operator at a server enters a URL, a time and a date to display a document associated with the URL. A configuration file is created for each entry. A program monitors the server system time and date and executes instructions to display the various URLs at the designated times. The term “date” is used herein to define calendar days, months, quarters etc. The term “time” refers to a specified interval during a given date. It will be apparent to those of ordinary skill in the art that the time and date a particular document is displayed can be specified in a number of ways and achieve the same result described in the present invention.

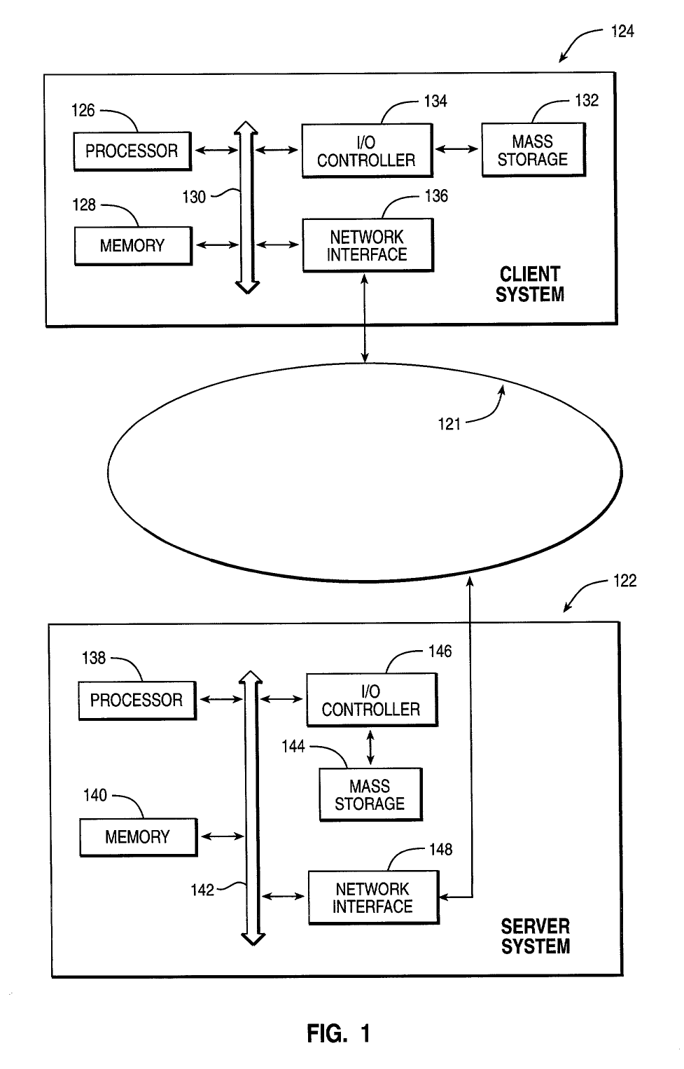

FIG. 1 depicts, an example of a client-server data processing system suitable for use in the present invention. In this example, a remote server system 122 is connected through a network 121 to client system 124. The client system 124 includes conventional components such as a processor 126, memory 128 (e.g. RAM), a bus 130 which couples the processor 126 and memory 128, a mass storage device 132 (e.g. a magnetic hard disk or an optical storage disk) coupled to the processor and memory through an I/O controller 134 and a network interface 136, such as a LAN connection or a conventional modem.

The server system 122 also includes conventional components such as a processor 138, memory 140 (e.g. RAM), a bus 142 which couples the processor 138 and memory 140, a mass storage device 144 (e.g. a magnetic or optical disk) coupled to the processor 138 and memory 140 through an I/O controller 146 and a network interface 148, such as a conventional modem. It will be appreciated from the description below that the present invention may be implemented in software which is stored as executable instructions on a computer readable medium on the client and server systems, such as mass storage devices 132 and 144 respectively, or in memories 128 and 140 respectively.

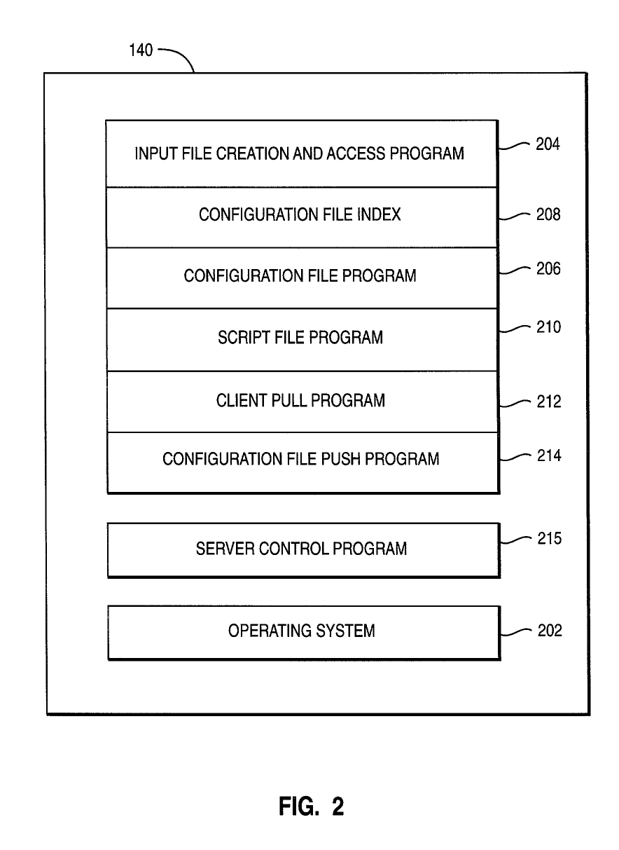

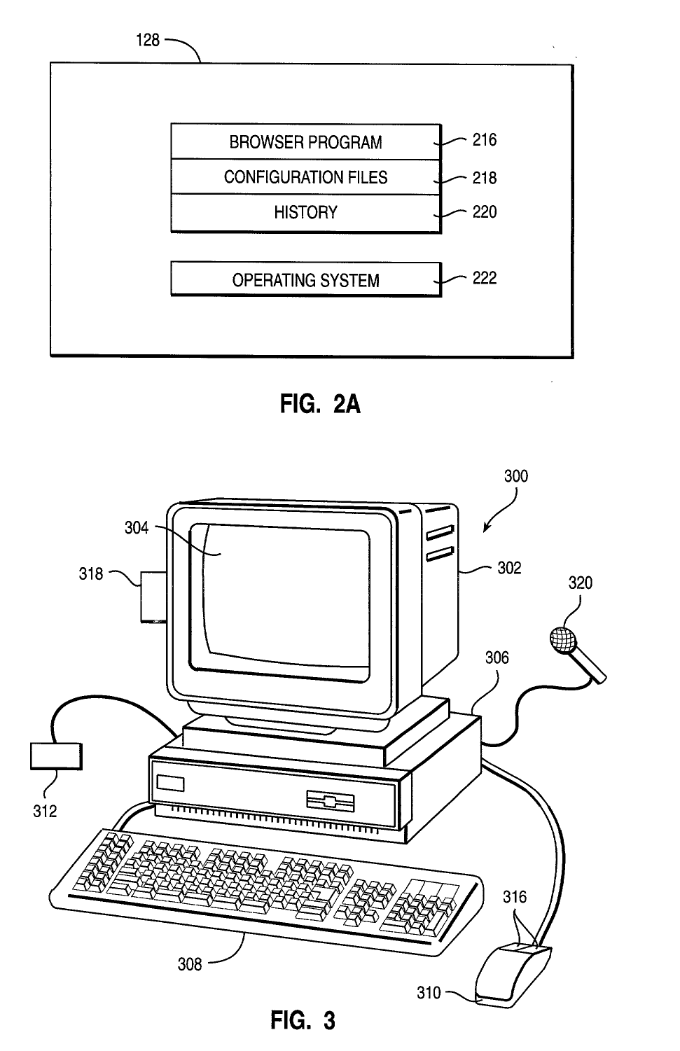

FIG. 2 is a block diagram of components found on the exemplary server system, shown in FIG. 1. Memory 140 is accessible by the CPU and stores program instructions executed by the processor 138. Memory 140 includes operating system 202 that runs a conventional server software application 204, such as AIX available from International Business Machines, Inc. Memory includes an input file creation and access program, 204 executed by a user to create input files and edit the input files as necessary. Configuration file generation program 206 compiles the information present in the input files and generates configuration files to be sent to the client. Configuration file index 208 stores the various configuration files sorted by client or groups of clients. Script file program 210 reads the information in input files and creates a schedule script for each file. Client information pull program 212 sends a request to a client for the current configuration and history information on the client system (discussed in FIG. 3) in response to a scheduled push operation. Configuration push program 214 combines any configuration and history from the client system with the current configuration file on the server and pushes the combined file out the client system. The existing configuration file at the client is replaced with the updated configuration file.

FIG. 2A is a block diagram of components found on client system 124, as shown in FIG. 1. Memory 128 is accessible by the CPU and stores program instructions executed by the processor 126. Memory 128 includes browser program 216, configuration files 218, history 220, and operating system 222. Browser program 216 such as Netscape Navigator, a registered trademark of Netscape Communications Corp. or Microsoft Internet Explorer, a registered trademark of Microsoft Corp., implements all of the regular functions of the browser. Browser 216 reads configuration files 218 and communicates requests over the network with the desired web server in order to display the information at the client. History 220 contains updated information as to web pages recently accessed by the client and bookmarks added by the client.

FIG. 3 is a schematic diagram of a client computer system 300 suitable for use in the present invention. The computer system 300 includes a display device 302 ,such as a monitor, a display screen 304, a cabinet 306 (which encloses components typically found in a computer, such as CPU, RAM, ROM, video card, hard drive, sound card, serial ports, etc.), a keyboard 308, a mouse 310, a microphone 320 and a modem 312. Mouse 310 may have one or more buttons, such as buttons 316. The computer requires some type of communication device such as modem 312 that allows computer system 300 to be connected to the Internet. Other possible communication devices include ethernet network cards.

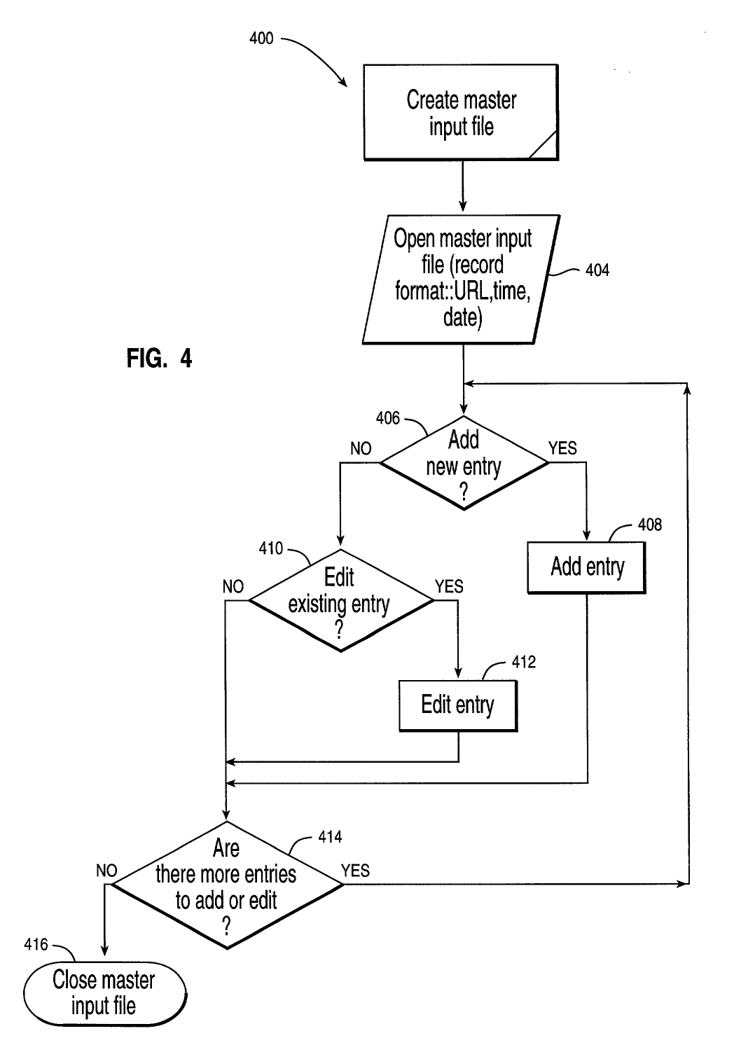

FIG. 4 is a flow diagram of a process 400 for creating a master input file in accordance with the present invention. The server administrator creates a master input file containing at least one record, step 404. Each record contains a URL field, a time field and a date field. The administrator is queried as to whether they want to add or edit a record in the master input file, step 406. The term “edit” is used herein to mean update the fields in an existing record and/or delete an existing record. If the answer at step 406 is “yes”, then they are prompted to enter the appropriate information for the new record entry, step 408. If the answer at step 406 is “no”, then they are queried as to whether they want to edit an existing record, step 410. If yes, then they proceed with editing at step 412. After adding and editing each entry, the program queries if there are additional entries to add or edit, step 414. If the answer to step 414 is “yes” then the program cycles back to step 406 until all of the desired records are added and/or edited. When there are no more files to add and/or edit, the program closes the master input file and the process ends, step 416.

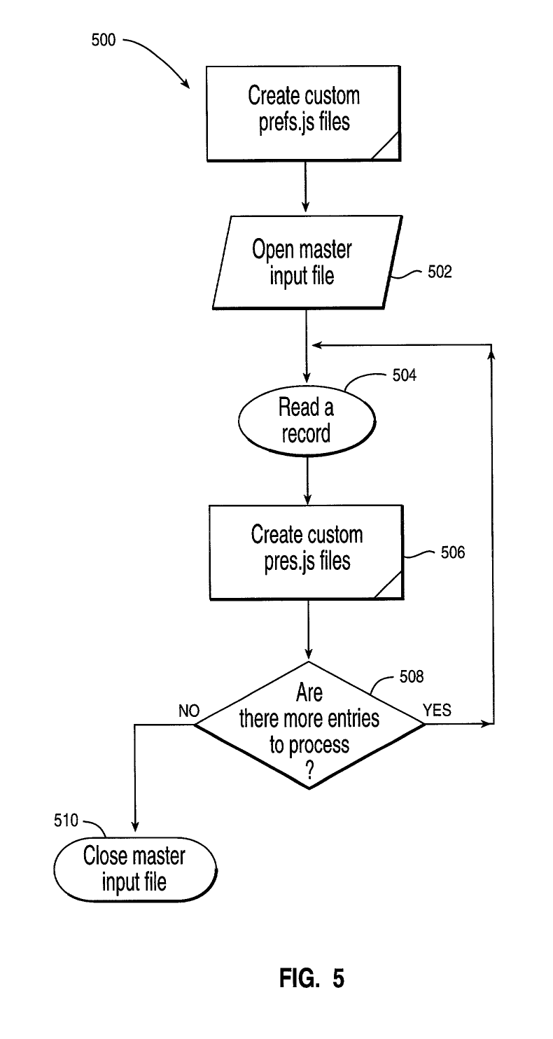

FIG. 5 is a flow diagram of a process 500 for creating custom preferences files on a client in accordance with a preferred embodiment of the present invention. The server executes a program containing instructions to open the master input file, step 502 and read the records, step 504. The program writes the URL information present in a record into a custom preferences file that is unique for that particular record, step 506. The program checks for additional entries to process, step 508. If there are more entries, then the process cycles back to step 504. When custom preferences files are created for each record present in the master input file, the master input file is closed and the process ends, step 510.

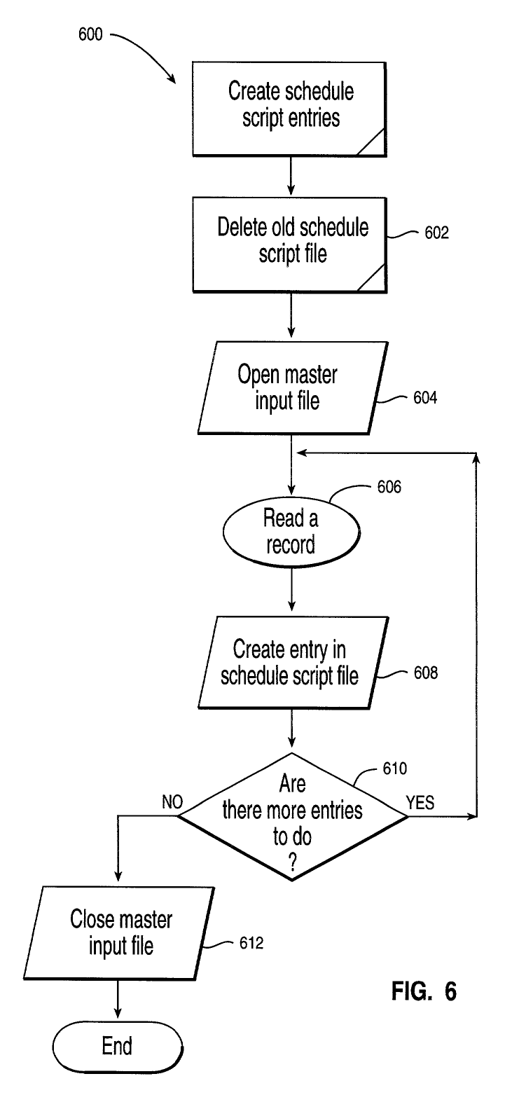

FIG. 6 is a flow diagram of a process 600 for creating schedule script files in accordance with the present invention. The server executes a program that deletes old or existing schedule script files, step 602. The program opens the master input file, step 604 and reads each record in the master input file, step 606. The program creates an entry in a new schedule script file in accordance with the time and date values present in a given record, step 608. The program checks for additional entries to be read, step 610. If there are more entries to be read, then the process cycles back to step 606. When schedule scripts are created for each record present in the master input file, the master input file is closed and the process ends, step 612.

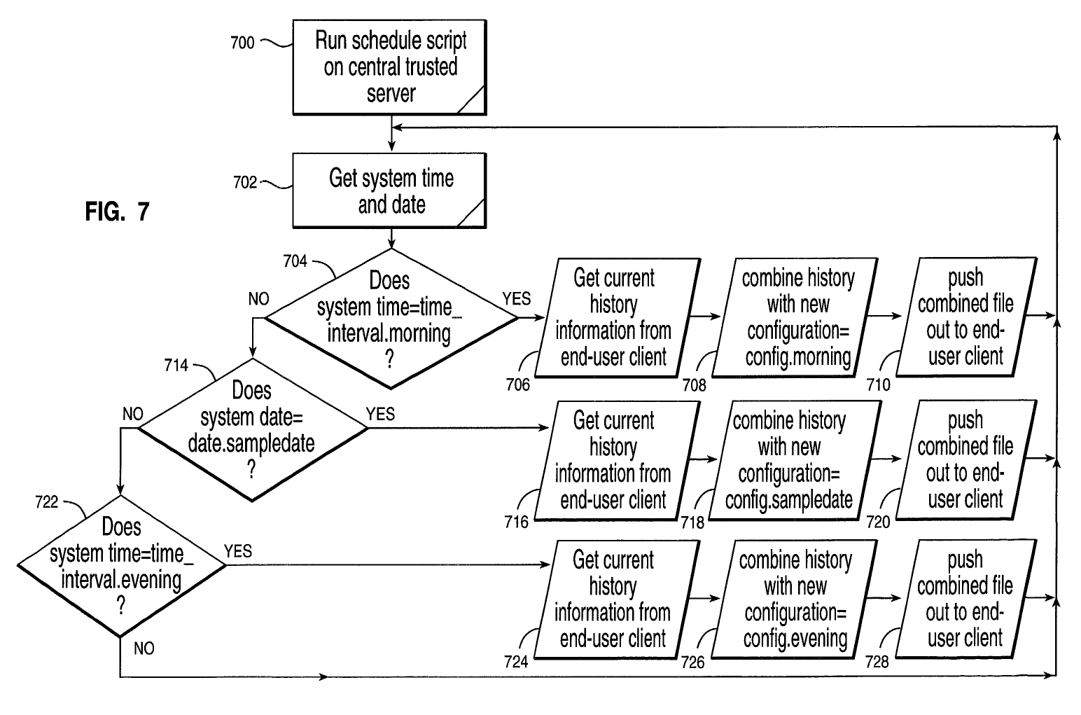

FIG. 7 is a flow diagram of an exemplary process 700 for customizing the configuration files at a client in accordance with one embodiment of the present invention. In this example, the following decision tree occurs on the trusted server where:

config_{standard} is defined as the configuration file normally maintained on the client system, all other factors being equal. (what factors?)

config_{morning} is defined as the configuration file defined between certain hours, for example 5 AM and 9 AM.

time_interval_{morning} is defined as the time interval for which the config_{morning} should be maintained on the client.

config_{evening} is defined as the configuration file defined between certain hours, for example 5 PM and 9 PM.

time_interval_{evening} is defined as the time interval for which the config_{evening} should be maintained on the client

config_{sampledate} is defined as the configuration file to take the place of config_{standard} on the sample date.

date_{sampledate} is defined as a date on which specialized config_{sampledate} should be loaded.

The server contains a script file that may run as often as the server administrator chooses. The script initially checks the system time and date, step 702. The script then considers the following for each of the server's clients. Does the system time fall within time_interval_{morning}?, step 704. If yes, then request current configuration and history information from client, step 706. Perform any necessary history and configuration file combination with config_{morning}, step 708. Push combined file out to client, step 710. The combination of the client and server configuration files could be accomplished using a known text parsing language, such as PERL, and would serve to maintain the user's web history and recent changes to bookmarks/favorites which may have transpired since the last config file was pused to the client. If the answer to step 704 is “no” then query does the system date fall upon ?date_{sampledate}, step 714. If yes, then request current configuration and history information from client, step 716. Perform any necessary history and configuration file combination with config_{sampledate}, step 718. Push combined file out to client, step 720. If no, then query does the system time fall within time_interval_{evening}?, step 722. If yes, then request current configuration and history information from client, step 724. Perform any necessary history and configuration file combination with config_{evening}, step 726. Push combined file out to client, step 728. If no, continue back to step 702.

Requests to pull current preferences/history information from the client may be completed prior to a scheduled push to the client. The pushed file preferably a merged version, containing all the most recent information from the client system combined with the chronologically-sensitive home page value. Thus, no relevant history would be lost during the configuration push, and the entire transaction could occur in a matter of a few seconds or less. The specifics of the text parsing used to merge the files can be accomplished by one of ordinary skill in the art.

The present invention allows the server administrator the flexibility to specify what home page is displayed to specific clients at any given time during the day, week, month, quarter, year, or any time frame they choose. The desired web documents are automatically displayed in accordance with the preferences set at the server without any further user intervention. This is advantageous in that the user does not need to remember to access a given URL on a specific date, making information retrieval and review much easier.

While the invention has been shown and described with reference to particular embodiments thereof, it will be understood by those skilled in the art that the foregoing and other changes in form and detail may be made therein without departing from the spirit and scope of the invention.

1. A method of enhancing information delivery to a client system, the method comprising:
accessing, at a server, at least one configuration file comprising instructions for displaying a URL at a given time and date;
verifying the server system time and date;
transmitting, from the server, a configuration file to the client; where the time and date function of the configuration file corresponds to the server system time and date; and
displaying a first document at the client based on a first system time and date.

2. The method of claim 1 further comprising displaying a second document at the client based on a second system time and date.

3. The method of claim 1 further comprising creating, at the server, an input file containing at least one record wherein each record comprises a URL, a time and a date.

4. The method of claim 3 further comprising creating a configuration file for each record.

5. The method of claim 3 further comprising creating a schedule script file for each record in the input file.

6. The method of claim 5 further comprising running a schedule script on the server and identifying configuration files having a date and time that corresponds to the system date and time.

7. A system for customizing content delivery to a client comprising:
a processor;
a memory coupled to the processor;
a computer readable medium coupled to the processor containing instructions for:
accessing, at a server, at least one configuration file comprising instructions for displaying a URL at a given time and date;
verifying the server system time and date;
transmitting, from the server, a configuration file to the client; where the time and date function of the configuration file corresponds to the server system time and date; and
displaying a first document at the client based on a first system time and date.

8. The system of claim 7 wherein the instructions further comprise displaying a second document at the client based on a second system time and date.

9. The system of claim 7 wherein the instructions further comprise creating, at the server, an input file containing at least one record wherein each record comprises a URL, a time and a date.

10. The system of claim 7 wherein the instructions further comprise creating a configuration file for each record and
copying the configuration file to a preferences file associated with a browser on the client upon the occurrence of a given system time and date.

11. The system of claim 9 wherein the instructions further comprise creating a schedule script file for each record in the input file.

12. The system of claim 11 further comprising running a schedule script on the server; and identifying configuration files having a date and time that corresponds to the current system date and time.

13. A computer readable medium on a client system containing executable program instructions for performing a method comprising:
accessing, at a server, at least one configuration file comprising instructions for displaying a URL at a given time and date;
verifying the server system time and date;
transmitting, from the server, a configuration file to the client; where the time and date function of the configuration file corresponds to the server system time and date; and
displaying a first document at the client based on a first system time and date.

14. The computer readable medium of claim 13 further comprising displaying a second document, at the client, based on a second system time and date.

15. The computer readable medium of claim 13 further comprising creating, at the client, the input file containing at least one record wherein each record comprises a URL, a time and a date.

16. The computer readable medium of claim 15 further comprising creating a configuration file for each record; and
copying the configuration file to a preferences file associated with a browser on the client upon the occurrence of a given system time and date.

17. The computer readable medium of claim 15 further comprising creating a schedule script file for each record in the input file.

18. The computer readable medium of claim 17 further comprising running a schedule script periodically; and identifying custom preferences files having a date and time that corresponds to the current system date and time.
